(19) United States
(12) Patent Application Publication
(10) Pub. No.: US 2005/0203754 A1
(43) Pub. Date: Sep. 15, 2005

(54) Method and system for collecting and distributing charitable contributions

(76) Inventor: Kevin Coughlin, Atlanta, GA (US)

Correspondence Address: CONNOLLY BOVE LODGE & HUTZ LLP, SUITE 800, 1990 M STREET NW, WASHINGTON, DC, 20036-3425, US

(21) Appl. No.: 10/795,298

(22) Filed: Mar. 9, 2004

(51) Int. Cl. G06F 17/60

(52) U.S. Cl. 705/1

(57) ABSTRACT

A method for collecting and distributing charitable funds. The method comprises: providing a consumer product; identifying one or more market providers to distribute the consumer product to a regional or local sales outlet; and processing sale information from the market providers. The sale information includes regional or local sales volume at the regional or local outlet. The method also includes identifying one or more regional or local charitable organizations. The charitable organizations are then provided with a contribution based upon a percentage of gross sale receipts obtained from the market provider or profits obtained from the sale of the product to the market provider, and the volume of product sold at the associated regional or local sales outlet.

### FIELD OF THE INVENTION

The invention relates to a method and system for collecting and distributing charitable contributions based upon the sale of consumer products. In particular, the method and system distributes the collected contributions to charitable organizations on a regional or local level based upon the respective region or locality where the products are purchased by the consumer.

### BACKGROUND OF THE INVENTION

Charitable organizations and commercial businesses are known to establish relationships to promote sales of specific products or the sale of products at specific retail outlets. The charitable organization benefits from the financial support received from the businesses. The businesses benefit from increase in sales or market share. Well established relationships often result in the development of goodwill for the associated product and retail provider, and public awareness for the charity. For instance, a company can adopt a system where a set donation is remitted by the company to a particular charity following the sale of one of the company's products. Also, there have been prior packaging systems which identify certain charities for the receipt of donations. In particular, Campbell's Soup Company® has a system where specially marked labels on soup cans can be forwarded to an elementary school. The school or school district then exchanges the soup labels for educational resources such as school supplies.

Cause Related Marketing (“CRM”) is a strategic positioning and marketing method, which links a company and its products to a social cause or issue. Using CRM, companies can enhance brand recognition, and differentiate similar products in a competitive marketplace, while providing discrete benefits to promote social programs or particular charitable causes. As a result, CRM can be a significant source of funding to address the social issues of the day, while at the same time addressing business-marketing objectives.

An example of a CRM-driven program is the Hormel CURE 81 Gift Certificate Program in which The Kroger Company (a supermarket chain) and Hormel® Foods (a food manufacturer) donated gift certificates for nearly 12,000 Hormel CURE 81 hams to non-profit organizations. In the Kroger-Hormel promotion, the volume of purchases made by Kroger customers of Hormel products determined the number of gift certificates that Hormel ultimately gave to non-profit organizations. These gift certificates were then given by the non-profit organizations to charitable donees to claim a Hormel ham in participating Kroger stores. Thus, by committing to donate Hormel ham gift certificates to a charity based upon the volume Hormel® Foods purchases in Kroger stores, Kroger and Hormel® Foods, Inc. effectively linked the “cause” of reducing the “food insecurity” of indigent persons with the commercial purpose of selling certain products through specific retailers.

In 1999, Americans collectively gave $190 billion in charitable gifts. However, only certain donations and expenses of cash or assets to qualified organizations are tax deductible, and the I.R.S. imposes strict limits on charitable contributions. For example, a donor will not be entitled to a deduction for any charitable contribution of $250 or more unless the donor has “contemporaneous” written substantiation from the charity. This provision does not place an information-reporting duty only on charities, but rather the donor is responsible for obtaining an acknowledgment from the charity for its tax records. As a result, there is a need for a system to track charitable contributions and generate reports associated with the charitable contributions from a respective donor participating in a CRM-driven program to satisfy I.R.S. reporting requirements.

### SUMMARY OF THE INVENTION

The invention is directed to a method for collecting and distributing charitable funds. The method comprises: providing a consumer product; identifying one or more market providers to distribute the consumer product to a regional or local sales outlet; and processing sale information from the market providers. The sale information includes regional or local sales volume at the regional or local outlets. The method also includes identifying one or more regional or local charitable organizations. The charitable organizations are then provided with a contribution based upon a percentage of gross sale receipts obtained from the market provider or profits obtained from the sale of the product to the market provider, and the volume of product sold at the associated regional or local sales outlet.

The method can include establishing a charitable foundation to account for the percentage of gross sale receipts obtained from the market provider, or profits obtained from the sale of the product to the market provider. The charitable foundation would then distribute the collected contributions to the associated regional or local sales charitable organizations.

Contributions are calculated from sale of product to the market provider. However, other entities involved with the product such as the market provider or a product manufacturer can also provide a contribution to the charitable foundation based on a percentage of profits or gross receipts resulting from the sale or manufacture of the product, respectively.

The method of can also include identifying the sale of the product with the associated local or regional charitable organization at the regional or local sales outlet with informational displays or literature.

The invention is also directed to a system for collecting and distributing charitable funds. The system comprises: a consumer product; one or more market providers to distribute the consumer product to a regional or local sales outlet; and a server to process sale information from the market providers. The sale information includes regional or local sales volume at the regional or local outlets. The system would also include one or more regional or local charitable organizations associated with the regional or local outlet. The charitable organizations are provided with a contribution based upon a percentage of gross sale receipts obtained from the market provider or on a percentage of profits obtained from the sale of the product to the market provider, and the volume of product sold at the associated regional or local sales outlet.

### BRIEF DESCRIPTION OF THE DRAWING

The invention will be better understood by reference to the Detailed Description of the Invention when taken together with the attached drawing, wherein

FIG. 1 is a schematic representation of one embodiment of the invention.

### DETAILED DESCRIPTION OF THE INVENTION

Present CRM programs do not provide for an integrated system which links a corporate entity charged with the responsibility of developing CRM programs with a market provider, a product manufacturer or a retail outlet, and then coordinates the charitable donations received to one or more regional or local charitable organizations based on product sales and the location where that product is purchased. Also, present CRM programs do not identify the sale of the product with a particular regional or local charitable organization. In the few instances that the sale of the product is identified with a particular charitable organization, that charitable organization is likely to have centers located throughout the country. Consequently, the consumer's purchase would provide little or no social impact within the consumer's region or locality. For example, proceeds from the sale of a product in the metro-Atlanta region could go to a center in Houston, Tex., or St. Louis, Mo., and not back into the Atlanta community. Applicant's invention recognizes the shortcomings of these prior business practices.

Furthermore, the charitable organization that will ultimately benefit from the consumer's purchase of the product is often not known to the consumer at the time of purchase. Often, the consumer purchases a product because the sale of the product is knowingly tied to a charitable foundation, however the consumer has little or no information as to the actual charitable organizations that benefit or the geographical reach of that benefit. For example, over 150 million in contributions has been made to numerous social needs and functions from the purchase of Newman's Own® products. This is certainly a worthy achievement. However, if one reviews the Company's web page, what one finds is that the contributions have been given to a number of social causes including the arts, affordable housing, children, disaster relief, education, the elderly, hunger relief and the environment. The sale of a particular product is not tied to a specific charitable organization. More importantly, the sale of the product is not tied to the region or locality where the product is purchased. Again, Applicant's invention recognizes the shortcomings of these prior business practices.

The method and system of the invention identifies and associates the sale of a product to a particular charitable organization that has regional or local centers within the geographic area where the product is purchased. Charitable contributions are then made to these centers based on the sale of the product. The product sales are tracked with an information server and sale summary reports are generated. The reports are then used to determine the amount of contributions made to regional or local charitable centers in the consumer's region or locality. As a result, the sale of the product, and the resulting charitable contribution, is identified with a charitable organization having a center in the consumer's region or locality.

The term “region” is defined as a geographic area having approximately a 100 mile radius from a regional or local sales outlet where the product is purchased. Similarly, the term “local or locality” is defined as a geographic area having approximately a 40 mile radius from a regional or local sales outlet where the product is purchased.

The method for collecting and distributing charitable funds comprises: providing a consumer product; identifying one or more market providers to distribute the consumer product to regional or local sales outlets; processing sale information from the market providers, wherein the information includes regional or local sales volume at the regional or local outlets; and identifying one or more regional or local charitable organizations, and provide the charitable organizations with a contribution based upon a percentage of gross sale receipts obtained from the market provider or profits obtained from the sale of the product to the market provider, and the volume of product sold at the associated regional or local sales outlets.

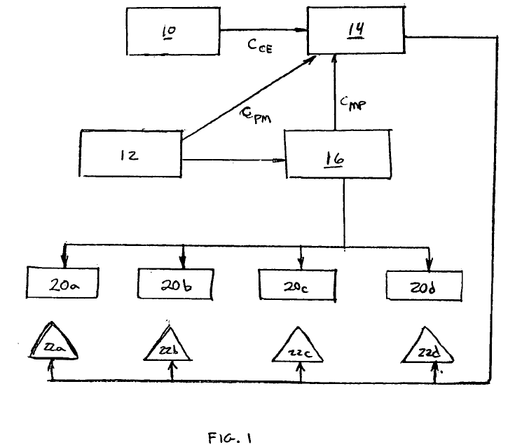

One embodiment of the invention is described in the schematic diagram of FIG. 1. As shown, a corporate entity 10 can establish a CRM program by identifying one or more consumer products suitable for the program. The corporate entity 10 establishes a relationship with a product manufacturer 12 to manufacture the one or more consumer products. Consumer products that are particularly suited for the program of the invention include high volume consumables such as packaged drinking water, household paper consumables, beverages, snacks, cereals, and prepared frozen foods.

The product can also include consumer services such as a credit card transaction. In this case, the use of a credit card by the consumer is tied to a selected local or regional charitable organization. For each transaction, a donation is made to the selected organization by the sponsoring financial institution.

Consumer products that are associated with relatively high profit margins are particularly suited because the high profit margins translates to a higher percentage rate of gross receipts that is provided by the corporate entity 10, and potentially the partners of the program, to the charitable organizations or to a charitable foundation 14.

The consumer product is provided to a market provider 16 for distribution. Transactions between the corporate entity, the product manufacturer and market provider can be conducted according to accepted and known business practices. For example, corporate entity 10 will contract with product manufacturer 12 to produce a consumer product at a specified cost, and provide the product to the market provider 16. Corporate entity 10 will then invoice the sale of the product to the market provider 16. The market provider 16 will submit payment, i.e., gross sales receipts, to corporate entity 10, who in turn will submit payment to the product manufacturer 12 for the cost of manufacture.

The method of the invention can further include establishing a charitable foundation 14 to account for contributions made through the program. The charitable foundation would then distribute the collected contributions to the associated regional or local sales charitable organizations.

The charitable foundation can be funded by numerous sources. One primary source of funding can be based on a percentage of gross sales receipts received by the corporate entity from the market provider. For example, the amount of a contribution C_{CE} made to the charitable foundation from the corporate entity is typically from 1% to 20%. Alternatively, the funding can be based on a percentage of profits obtained from the sale of the product to the market provider.

Another source can be from the market provider itself. For example, the market provider can choose to become a partner in the program. In one embodiment, the market provider 16 can make contributions C_{MP} to the charitable foundation 14 based on a percentage of its profits or its gross receipts resulting from the sale of the product. Partnership in the program can bring many advantages including identification of the market provider with the one or more regional or local charitable organizations resulting in the return of goodwill.

Another source of funding can be from the product manufacturer. The product manufacturer can also become a partner in the program and provide a contribution C_{PM} to the charitable foundation based on a percentage of profits or gross receipts obtained from the manufacture of the product.

A market provider can be a regional or local distributor that distributes a number of different consumer products to retail sales outlets. In many cases, the market provider and the retails sales outlets belong to the same corporate entity. For example, a market provider can be a national and regional supermarket chain with regional and local sales outlets. The market provider can also be a retail chain such as WalMart®, Target® or Home Depot® with regional and local sales outlets.

The market provider delivers the product to the local and regional sales outlets 20a, 20b, 20c and 20d where the products are purchased by the consumer. The market provider is also equipped with a tracking system to provide an accounting as to the volume and revenue of sales of the product at each of the associated local or regional outlets. This accounting or sales summary information is provided to the corporate entity 10 or to the charitable foundation 14. The corporate entity or the charitable foundation uses the sales summary information to determine the amount of contributions to be made to each of the associated regional or local charitable organizations 22a, 22b, 22c and 22d, respectively.

The method of the invention allows for the purchase of each product to be specifically associated with one or more regional or local charitable organizations. In addition, each product can be associated with each of the local or regional charitable organizations at the regional or local sales outlet with informational displays or literature. The informational displays or informational literature provides the consumer with sufficient information to make an informed decision in the purchase of the product. Consumers with such knowledge are more likely to purchase a product if they are told how much of the purchase price will go a charity specifically identified with the product. The informational displays or literature will typically be provided by the corporate entity or the charitable foundation to the retails sales outlets directly or to the retail sales outlet through the market providers.

The local and regional charitable organizations will be selected form one or more organizations that focus on providing needed and often neglected assistance to women, children, the elderly, and the homeless. The charitable organizations chosen will provide any number of need services including providing food, clothing, shelter and medical care. The charitable organizations can include local and regional shelters and food banks and, organizations that assist various volunteer groups who provide similar needed benefits to those with the most needs in each community.

The method can also include an accounting for the amount of contributions made to the one or more charitable organizations, and the amount provided to each of the organizations from each participant or corporate partner in the program. This information can then be provided to the participants and partners in the form of contribution reports for I.R.S. tax recordation.

The invention is also directed to a system for collecting and distributing charitable funds comprising: one or more market providers to distribute a consumer product to a regional or local sales outlet; a server to process sale information from the market providers, wherein the sale information includes regional or local sales volume at the regional or local outlet; and one or more regional or local charitable organizations associated with the regional or local outlet, wherein the charitable organizations are provided with a contribution based upon a percentage of gross sale receipts obtained from the market provider or on a percentage of profits obtained from the sale of the product to the market provider, and the volume of product sold at the associated regional or local sales outlet.

The system can further include a charitable foundation to account for the percentage of gross sale receipts received from the market provider or on the percentage of profits obtained from the sale of the product to the market provider, and to distribute the contributions to the one or more charitable organizations.

1. A method for collecting and distributing charitable funds comprising:
providing a consumer product;
identifying one or more market providers to distribute the consumer product to a regional or local sales outlet;
processing sale information from the market providers, wherein the information includes regional or local sales volume at the regional or local sales outlet; and
identifying one or more regional or local charitable organizations, and provide the charitable organizations with a contribution based upon a percentage of gross sale receipts obtained from the market provider or profits obtained from the sale of the product to the market provider, and the volume of product sold at the associated regional or local sales outlet.

2. The method of claim 1 further comprising establishing a charitable foundation to account for the percentage of gross sale receipts obtained from the market provider, or profits obtained from the sale of the product to the market provider.

3. The method of claim 2 wherein the charitable foundation distributes the collected contributions to the associated regional or local sales charitable organizations.

4. The method of claim 2 wherein the market provider provides a contribution to the charitable foundation based on a percentage of profits or gross receipts resulting from the sale of the product.

5. The method of claim 2 wherein a product manufacturer provides a contribution to the charitable foundation based on a percentage of profits or gross receipts obtained from the manufacture of the product.

6. The method of claim 1 further comprising identifying the sale of the product with the associated local or regional charitable organization.

7. The method of claim 1 wherein the percentage of gross sales receipts received from the market provider is from 1% to 20%.

8. The method pf claim 6 wherein the associated local or regional charitable organization is associated with the product at the regional or local sales outlet with informational displays or literature.

9. The method of claim 1 wherein the consumer product is selected from packaged drinking water, household paper consumables, beverages, snacks, cereals, frozen prepared foods and credit card services.

10. The method of claim 1 wherein charitable organizations are provided with a contribution based upon a percentage of gross sale receipts obtained from the market provider.

11. The method of claim 1 wherein charitable organizations are provided with a contribution based upon a percentage of profits obtained from the sale of the product to the market provider.

12. The method of claim 1 further comprising generating reports for tax recordation.

13. A system for collecting and distributing charitable funds comprising:
a consumer product;
one or more market providers to distribute the consumer product to a regional or local sales outlet;
a server to process sale information from the market providers, wherein the sale information includes regional or local sales volume at the regional or local outlet; and
one or more regional or local charitable organizations associated with the regional or local outlet, wherein the charitable organizations are provided with a contribution based upon a percentage of gross sale receipts obtained from the market provider or on a percentage of profits obtained from the sale of the product to the market provider, and the volume of product sold at the associated regional or local sales outlet.

14. The system of claim 13 further comprising a charitable foundation to account for the percentage of gross sale receipts received from the market provider or on the percentage of profits obtained from the sale of the product to the market provider, and to distribute the contributions to the one or more charitable organizations.

15. The system of claim 13 wherein the associated local or regional charitable organization is associated with the product at the regional or local sales outlet with informational displays or literature.

16. The system of claim 13 wherein the consumer product is selected from packaged drinking water, household paper consumables, beverages, snacks, cereals, frozen prepared foods and credit card services.

17. The system of claim 13 wherein charitable organizations are provided with a contribution based upon a percentage of gross sale receipts obtained from the market provider.

18. The system of claim 13 wherein charitable organizations are provided with a contribution based upon a percentage of profits obtained from the sale of the product to the market provider.

19. A method for collecting and distributing charitable funds comprising:
providing a consumer product;
identifying one or more market providers to distribute the consumer product to a regional or local sales outlet;
processing sale information from the market providers, wherein the information includes regional or local sales volume at the regional or local sales outlet; and
identifying one or more regional or local charitable organizations, and provide the charitable organizations with a contribution based upon a percentage of gross sale receipts obtained from the market provider, and the volume of product sold at the associated regional or local sales outlet.

20. The method of claim 19 further comprising establishing a charitable foundation to account for the percentage of gross sale receipts obtained from the market provider.

21. The method of claim 20 wherein the market provider provides a contribution to the charitable foundation based on a percentage of profits or gross receipts resulting from the sale of the product.

22. The method of claim 20 wherein a product manufacturer provides a contribution to the charitable foundation based on a percentage of profits or gross receipts obtained from the manufacture of the product.

23. The method of claim 19 further comprising identifying the sale of the product with the associated local or regional charitable organization.
